(19) United States
(12) Patent Application Publication
(10) Pub. No.: US 2022/0209603 A1
(43) Pub. Date: Jun. 30, 2022

(54) MOTOR INCLUDING COOLING CHANNEL

(71) Applicants: Hyundai Motor Company, Seoul (KR); Kia Corporation, Seoul (KR)

(72) Inventors: Jun Young KIM, Seoul (KR); Shin Jong Kim, Hwaseong-Si (KR); Sang Jin Park, Hwaseong-si (KR)

(73) Assignees: Hyundai Motor Company, Seoul (KR); Kia Corporation, Seoul (KR)

(21) Appl. No.: 17/375,220

(22) Filed: Jul. 14, 2021

(30) Foreign Application Priority Data
Dec. 29, 2020 (KR) 10-2020-0186529

(51) Int. Cl. H02K 1/32; H02K 9/19; H02K 5/20

(52) U.S. Cl. CPC H02K 1/32; H02K 5/203; H02K 9/19

(57) ABSTRACT

A motor may include a cooling channel formed in a rotor core including a plurality of stacked metal sheets, wherein the plurality of metal sheets has flow path holes that are positioned at different distances from a center portion of the rotor core such that the flow path holes in the plurality of metal sheets define a cooling channel which is inclined at a predetermined slope with respect to a rotation axis of the rotor core and has a stepped cross-section when the plurality of metal sheets is stacked one on another, increasing the cooled area of the rotor core, that is, the area in contact with the cooling fluid and thus maximizing the cooling effect of the rotor core.

### CROSS-REFERENCE TO RELATED APPLICATION

The present application claims priority to Korean Patent Application No. 10-2020-0186529 filed on Dec. 29, 2020, the entire contents of which is incorporated herein for all purposes by this reference.

### BACKGROUND OF THE INVENTION

### Field of the Invention

The present invention relates to a motor including a cooling channel. More particularly, it relates to a motor including a cooling channel, which is formed in a rotor core to have a stepped cross-section, increasing the cooled area of the rotor core and thus maximizing the cooling effect of the rotor core.

### Description of Related Art

An eco-friendly vehicle, such as an electric vehicle, a hybrid vehicle or a fuel-cell vehicle, is provided with a drive motor such as a synchronous motor or an induction motor as a traveling drive source.

Generally, such a motor includes a stator unit, which includes a stator core including a plurality of stacked metal sheets and a coil wound around the stator core, and a rotor unit, which includes a rotor core including a plurality of stacked metal sheets and a shaft fitted into the rotor core.

Because the rotor core constituting the rotor unit of the motor generates high-temperature heat, which causes a performance deterioration of the motor due to induction current, the rotor core may be cooled.

In the conventional technology, although a rotor core provided with a cooling channel for circulation of cooling fluid to cool the rotor core using cooling fluid (for example, oil or the like), has been used, there is a problem in that it is impossible to satisfy a target cooling performance owing to the influence of electromagnetic flow or the like.

Accordingly, there is demand for a cooling channel having an optimal structure for cooling a rotor core.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a motor including a cooling channel formed in a rotor core including a plurality of stacked metal sheets, wherein the plurality of metal sheets has therein flow path holes, which are positioned at different distances from a center portion of the rotor core such that the flow path holes in the plurality of metal sheets define the cooling channel, which is inclined at a predetermined slope with respect to a rotation axis of the rotor core and has a stepped cross-section, when the metal sheets are stacked one on another, increasing the area of the rotor core which is used for cooling, that is, the area contacting with the cooling fluid, and thus maximizing the cooling effect of the rotor core.

Various aspects of the present invention are directed to providing a motor including a cooling channel formed in a rotor core including a plurality of stacked metal sheets, wherein the plurality of metal sheets has flow path holes that are positioned at different distances from a center portion of the rotor core such that the flow path holes in the plurality of metal sheets define the cooling channel, which is inclined at a predetermined slope with respect to a rotation axis of the rotor core and has a stepped cross-section, while the metal sheets are stacked one on another.

In various exemplary embodiments of the present invention, the cooling channel may include an inlet positioned adjacent to a rotor shaft in a radial direction of the rotor core in a first end surface of the rotor core and an outlet positioned close to an external surface of the rotor core in a second end surface of the rotor core.

In another exemplary embodiment of the present invention, cooling fluid may be introduced into the inlet of the cooling channel, may flow through the flow path holes in the plurality of metal sheets and may be discharged from the outlet of the cooling channel by centrifugal force resulting from rotation of the rotor core.

In yet another exemplary embodiment of the present invention, the flow path hole in the one among the plurality of metal sheets which is positioned at the inlet of the cooling channel may have a cut portion extending toward a rotor shaft for introducing the cooling fluid into the cooling channel.

In yet another exemplary embodiment of the present invention, the cooling channel may include a first cooling channel, which is inclined from a first end surface to a second end surface of the rotor core with a first predetermined angle with respect to the rotation axis of the rotor core and has a stepped cross-section, and a second cooling channel, which is inclined from the second end surface to the first end surface of the rotor core with a second predetermined angle with respect to the rotation axis of the rotor core and has a stepped cross-section.

In still yet another exemplary embodiment of the present invention, cooling fluid may flow from an inlet to an outlet of the first cooling channel when a vehicle travels forwards by a rotation of the motor in a first direction, and may flow from an inlet to an outlet of the second cooling channel when the vehicle performs speed reduction or travels backwards by a rotation of the motor in the opposite direction thereof.

In a further exemplary embodiment of the present invention, the first cooling channel and the second cooling channel may be configured symmetrically with each other.

In another further exemplary embodiment of the present invention, the first cooling channel may include a number of first cooling channels, and the second cooling channel may include a number of second cooling channels, the number of first cooling channels being greater than the number of second cooling channels.

Other aspects and exemplary embodiments of the present invention are discussed infra.

It is to be understood that the term “vehicle” or “vehicular” or other similar terms used herein are inclusive of motor vehicles in general, such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative-fuel vehicles (e.g., fuels derived from resources other than petroleum). As referred to herein, a hybrid vehicle is a vehicle that has two or more sources of power, for example a vehicle powered by both gasoline and electricity.

The above and other features of the present invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view exemplarily illustrating a rotor core of a motor including a cooling channel according to various exemplary embodiments of the present invention;

FIG. 2 is a rear view exemplarily illustrating the rotor core of the motor including the cooling channel according to various exemplary embodiments of the present invention;

FIG. 3 is a cross-sectional view taken along line A-A in FIG. 1;

FIG. 4 is a cross-sectional view taken along line B-B in FIG. 2;

FIG. 5 is a cross-sectional view exemplarily illustrating cooling fluid flowing through the cooling channel when the rotor core mounted on a rotor shaft according to various exemplary embodiments of the present invention is rotated in one direction thereof; and

FIG. 6 is a cross-sectional view exemplarily illustrating the cooling fluid flowing through the cooling channel when the rotor core mounted on a rotor shaft according to various exemplary embodiments of the present invention is rotated in the opposite direction thereof.

It may be understood that the appended drawings are not necessarily to scale, presenting a somewhat simplified representation of various exemplary features illustrative of the basic principles of the present invention. The specific design features of the present invention as included herein, including, for example, specific dimensions, orientations, locations, and shapes, will be determined in part by the particular intended application and use environment.

In the figures, the reference numbers refer to the same or equivalent parts of the present invention throughout the several figures of the drawing.

### DETAILED DESCRIPTION

Hereinafter, reference will now be made in detail to various embodiments of the present invention, examples of which are illustrated in the accompanying drawings and described below. While the present invention will be described in conjunction with exemplary embodiments of the present invention, it is to be understood that the present description is not intended to limit the present invention to those exemplary embodiments. On the contrary, the present invention is intended to cover not only the exemplary embodiments of the present invention, but also various alternatives, modifications, equivalents and other embodiments that may be included within the spirit and scope of the present invention as defined by the appended claims.

Hereinafter, exemplary embodiments of the present invention will be described in detail with reference to the accompanying drawings.

As mentioned above, an induction motor, which is mounted as a traveling drive source on an eco-friendly vehicle, includes a stator unit, around which a stator coil is wound, and a rotor unit in which a rotor core including a plurality of stacked metal sheets is coupled to a rotor shaft.

Because the rotor core constituting the rotor unit generates a large amount of heat resulting from induction current, which causes a performance deterioration of the motor, the rotor core may necessarily be cooled to ensure improvement and maintenance of performance of the motor.

To the present end, the present invention is characterized in that a plurality of metal sheets, forming the rotor core, have therein flow path holes, which are positioned at different distances from the common center portion of the metal sheets such that the flow path holes in the plurality of metal sheets define a stepped cooling channel having a predetermined slope when the plurality of metal sheets is stacked.

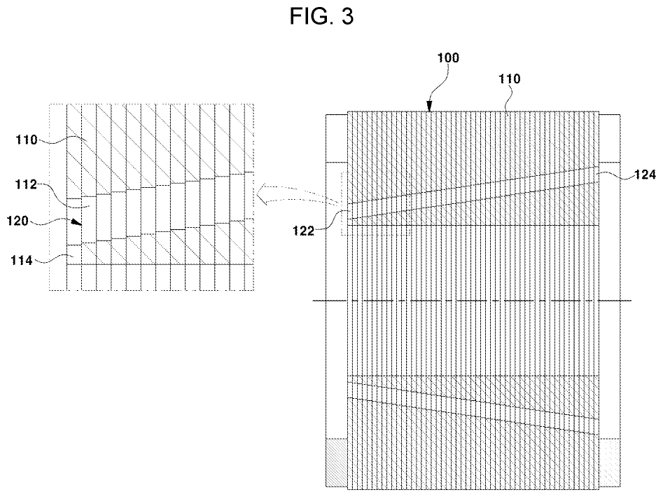

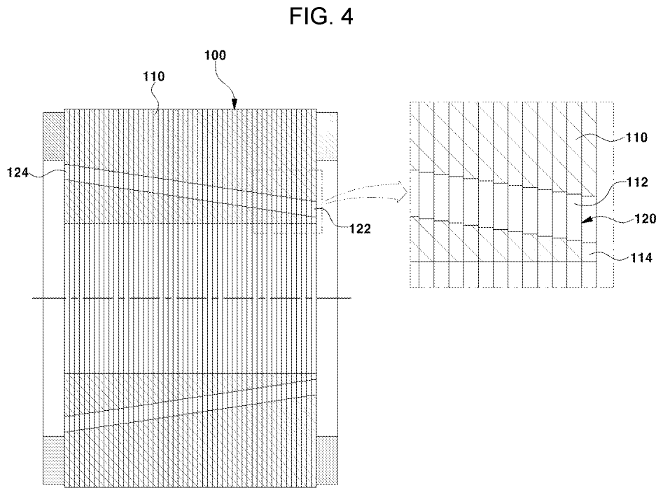

FIG. 3 and FIG. 4 are cross-sectional views exemplarily illustrating the motor having the cooling channel. In these drawings, reference numeral 100 denotes the rotor core.

The rotor core 100 includes a plurality of stacked metal sheets 110.

The metal sheets 110 have flow path holes 112, which are positioned at different distances from the common center portion of the metal sheets 110.

For example, each of the plurality of metal sheets 110 includes an annular plate having about 0.25-0.50 mm, and one of flow path holes 112 deviates from an adjacent flow path hole by about ±0.05°.

When the plurality of metal sheets 110, which have the holes formed in the above-mentioned fashion, are stacked to form the rotor core 100, the flow path holes 112 in the metal sheets 110 define the stepped cooling channel 120 having a predetermined slope in cross-section.

When each of the metal sheets 110 is provided therein with a plurality of flow path holes 112, which are circumferentially arranged at predetermined intervals, a plurality of cooling channels 120, each of which has a predetermined slope, may be formed in the rotor core 100.

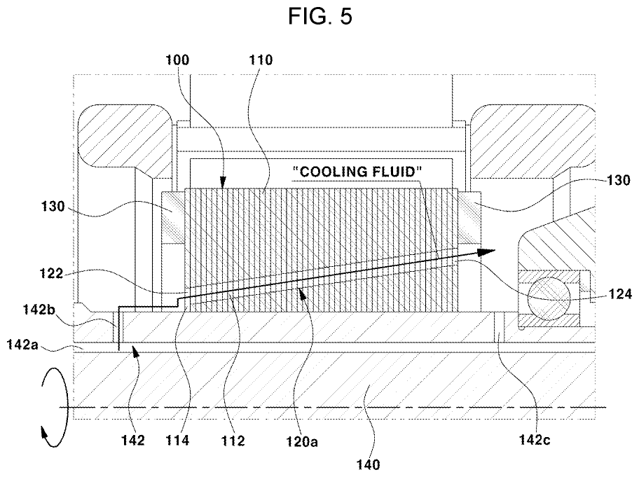

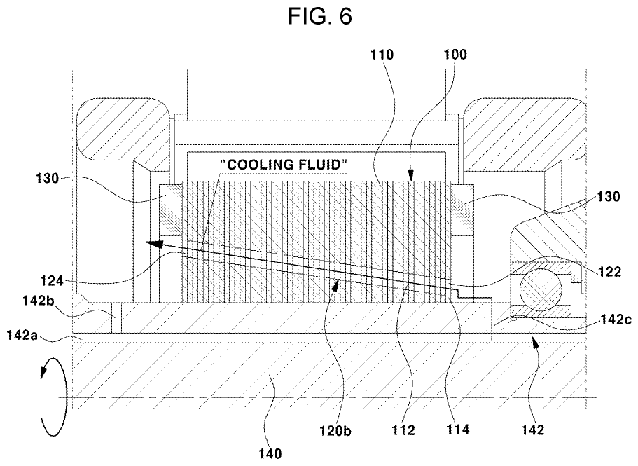

Referring to FIG. 5 and FIG. 6, end rings 130 are disposed on the two end portions of the rotor core 100 under pressure to hold the stacked metal sheets 110, and a rotor shaft 140 is fitted into the central hole in the rotor core 100 and is fastened thereto.

Consequently, the inlet 122 of the cooling channel 120 is formed in one end surface of the rotor core 100 at a position adjacent to the rotor shaft 140, and the outlet 124 of the cooling channel 120 is formed in the other end surface of the rotor core 100 at a position adjacent to the external surface of the rotor core 100.

Although not illustrated in the drawings, the rotor core 100, end rings 130, the rotor shaft 140 and the like may be disposed in a motor housing, and a predetermined amount of cooling fluid (for example, oil) may be charged or supplied into the motor housing.

Furthermore, the rotor shaft 140 may be provided therein with a fluid flow channel 142 extending in axial and radial directions, through which cooling fluid flows.

In an exemplary embodiment of the present invention, the fluid flow channel 142 includes a first fluid flow channel 142a passing through the body of the rotor shaft 140 in an axial direction of the rotor shaft 140, and second fluid flow channel 142b and third fluid flow channel 142c passing through the body of the rotor shaft 140 in a radial direction of the rotor shaft 140.

Accordingly, when the rotor core 100 is rotated by a rotation of the rotor shaft 140, the cooling fluid is introduced into the inlet 122 of the cooling channel 120, flows through the flow path holes 112 in the individual metal sheets 110, and is discharged from the outlet 124 of the cooling channel 120, by the centrifugal force resulting from the rotation of the rotor core 100, as indicated by the arrow in FIG. 5 and FIG. 6, cooling the rotor core 100 using the cooling fluid.

Since the cooling channel 120 has a stepped cross-section, the cooling fluid comes into contact not only with the internal surfaces of the flow path holes 112 in the individual metal sheets 110 forming the rotor core 100 but also with side surfaces of the metal sheets 110 while flowing through the cooling channel 120. As a result, it is possible to increase the cooled area of the rotor core 100, that is, the area contacting with the cooling fluid, and thus it is possible to maximize the cooling effect of the rotor core 100.

Furthermore, since the cooling fluid is configured for performing cooling while smoothly flowing through the cooling channel 120 by the centrifugal force resulting from the rotor core 100, it is possible to eliminate the demand for an additional hydraulic device or pump, which is conventionally used to forcibly circulate the cooling fluid for cooling the rotor core 100, and thus it is possible to reduce the number of components and the costs required to construct the motor cooling system.

Here, the flow path hole 112 in the one among the plurality of metal sheets 110 which is positioned at the inlet 122 of the cooling channel 120 is further provided with a cut portion 114, which extends toward the rotor shaft 140 such that the cooling fluid 120 is more easily introduced into the cooling channel 120 by the centrifugal force.

Therefore, when the rotor core 100 is rotated by a rotation of the rotor shaft 140, the cooling fluid is easily introduced into the cooling channel 120 through the cut portion 114 by the centrifugal force resulting from the rotation of the rotor core 100.

The cooling channel 120 may include a first cooling channel 120a, which extends from a first end surface to a second end surface of the rotor core 100 while being inclined radially and outwardly and which has a stepped cross-section, as illustrated in FIG. 3, and a second cooling channel 120b, which extends from the second end surface to the first second end surface while being inclined radially and outwardly and which has a stepped cross-section, as illustrated in FIG. 4.

In other words, the first cooling channel 120a and the second cooling channel 120b are different from each other only with regard to the direction in which the cooling channel is inclined, and have a symmetrical configuration.

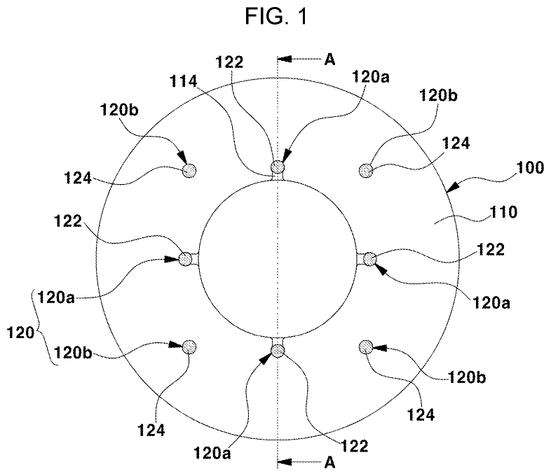

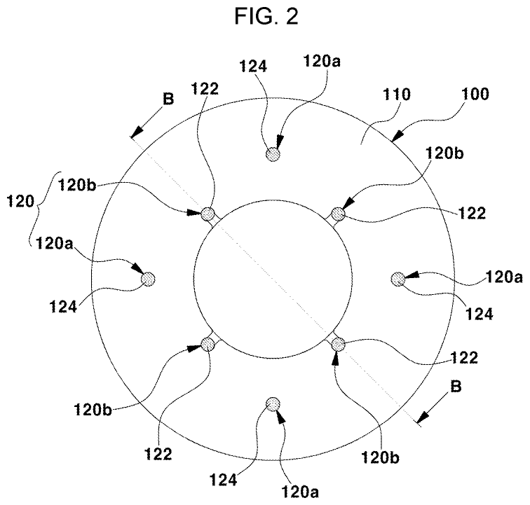

In the first end surface of the rotor core 100, the inlet 122 of the first cooling channel 120a is positioned adjacent to the internal surface of the central hole in the rotor core 100 while the outlet 124 of the second cooling channel 120b is positioned close to the external surface of the rotor core 100, as illustrated in FIG. 1. Meanwhile, in the second end surface of the rotor core 100, the inlet 122 of the second cooling channel 120b is positioned adjacent to the internal surface of the central hole in the rotor core 100 while the outlet 124 of the first cooling channel 120a is positioned close to the external surface of the rotor core 100, as illustrated in FIG. 2.

Consequently, when an eco-friendly vehicle travels forwards by a rotation of the motor in one direction thereof, the cooling fluid flowing through the second fluid flow channel 142b connected to the first fluid flow channel 142a cools the rotor core 100 while flowing from the inlet 122 to the outlet 124 of the first cooling channel 120a by centrifugal force. Meanwhile, when the eco-friendly vehicle performs speed reduction or travels backwards by a rotation of the motor in the opposite direction thereof, the cooling fluid flowing through the third fluid flow channel 142c connected to the first fluid flow channel 142a cools the rotor core 100 while flowing from the inlet 122 to the outlet 124 of the second cooling channel 120b by centrifugal force.

Here, because the eco-friendly vehicle more frequently performs forward traveling than backward traveling, the number of first cooling channels 120a be greater than the number of second cooling channels 120b for efficient cooling of the rotor core 100.

Since the rotor core 100 is continuously cooled even when the direction of rotation of the motor is changed due to the switching between forward traveling and backward traveling of the eco-friendly vehicle, it is possible to greatly improve the performance of cooling the motor.

By the above-described construction, the present invention offers the following effects.

First, since the metal sheets of the rotor core having flow path holes positioned at different distances from the common center portion of the metal sheets, are stacked one on another such that the flow path holes define a cooling channel having a stepped cross-section, it is possible to increase the cooled area of the rotor core contacting with the cooling fluid and thus to maximize the cooling effect of the rotor core.

Second, since the cooling fluid flows through the cooling channel by the centrifugal force resulting from the rotation of the rotor core even without using an additional hydraulic device, pump or the like for forcibly circulating the cooling fluid, it is possible to easily cool the rotor core.

Third, since the cooling channel formed in the rotor core includes the first cooling channel, which is inclined radially and outwardly from the first side to the second side, and the second cooling channel, which is inclined radially and outwardly from the second side to the first side such that the cooling fluid cools the rotor core while flowing through the first cooling channel by the centrifugal force when a vehicle travels forwards by a rotation of the motor in one direction and such that the cooling fluid cools the rotor core while flowing through the second cooling channel by the centrifugal force when the vehicle performs speed reduction or travels backwards by a rotation of the motor in the opposite direction thereof, it is possible to maximize the performance of cooling the rotor core.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A motor comprising:
a cooling channel formed in a rotor core including a plurality of stacked metal sheets,
wherein the plurality of metal sheets has at least a flow path hole that is positioned at a different distance from a rotation axis of the rotor core so that the at least a flow path hole in the plurality of metal sheets defines the cooling channel, which is inclined at a predetermined slope with respect to the rotation axis of the rotor core and has a stepped cross-section, while the plurality of metal sheets is stacked one on another.

2. The motor of claim 1, wherein the cooling channel includes an inlet positioned adjacent to a rotor shaft to which the rotor core is coupled, in a radial direction of the rotor core in a first end surface of the rotor core and an outlet positioned adjacent to an external surface of the rotor core in the radial direction of the rotor core in a second end surface of the rotor core

3. The motor of claim 2, wherein cooling fluid is introduced into the inlet of the cooling channel, flows into the at least a flow path hole formed through the plurality of metal sheets and is discharged from the outlet of the cooling channel by centrifugal force resulting from rotation of the rotor core.

4. The motor of claim 3, wherein the cooling fluid is introduced into the inlet of the cooling channel, from a fluid flow channel formed inside a body of the rotor shaft.

5. The motor of claim 1, wherein a flow path hole in one metal sheet among the plurality of metal sheets at the inlet of the cooling channel has a cut portion extending toward a rotor shaft to which the rotor core is coupled, for introducing cooling fluid into the cooling channel.

6. The motor of claim 5, wherein the cut portion is formed by cutting a portion of an internal circumference in the one metal sheet outwards in a radial direction of the rotor shaft in a predetermined length.

7. The motor of claim 1, wherein the cooling channel includes a first cooling channel, which is inclined from a first end surface to a second end surface of the rotor core with a first predetermined angle with respect to the rotation axis of the rotor core, and a second cooling channel, which is inclined from the second end surface to the first end surface of the rotor core with a second predetermined angle with respect to the rotation axis of the rotor core.

8. The motor of claim 7, wherein the first cooling channel has a series of first stepped cross-sections, and the second cooling channel has a series of second stepped cross-sections.

9. The motor of claim 7,
wherein an inlet of the first cooling channel is located adjacent to the rotation axis of the rotor core closer than an outlet of the second cooling channel in the radial direction of the rotor core in the first end surface of the rotor core, and
wherein an inlet of the second cooling channel is located adjacent to the rotation axis of the rotor core closer than an outlet of the first cooling channel in the radial direction of the rotor core in the second end surface of the rotor core.

10. The motor of claim 9, wherein cooling fluid flows from the inlet of the first cooling channel to the outlet of the first cooling channel when a vehicle travels forwards by a rotation of the motor in a first direction, and flows from the inlet of the second cooling channel to the outlet of the second cooling channel when the vehicle performs speed reduction or travels backwards by a rotation of the motor in a second direction which is opposite to the first direction.

11. The motor of claim 7, wherein the first cooling channel and the second cooling channel are configured symmetrically with each other.

12. The motor of claim 7,
wherein cooling fluid is introduced into inlets of the first and second cooling channels, from a fluid flow channel formed inside a body of a rotor shaft to which the rotor core is coupled,
wherein the fluid flow channel includes a first fluid flow channel passing through the body of the rotor shaft in an axial direction of the rotor shaft, a second fluid flow channel connected to the first fluid flow channel and passing through the body of the rotor shaft in a radial direction of the rotor shaft in front of the first end surface of the rotor core, and a third fluid flow channel connected to the first fluid flow channel and passing through the body of the rotor shaft in the radial direction of the rotor shaft in front of the second end surface of the rotor core.

13. The motor of claim 10, wherein the first cooling channel includes a number of first cooling channels, and the second cooling channel includes a number of second cooling channels, the number of first cooling channels being equal to or greater than the number of second cooling channels.

14. A motor comprising:
a cooling channel formed in a rotor core including a plurality of stacked metal sheets,
wherein the plurality of metal sheets has at least a flow path hole that is positioned at a different distance from a rotation axis of the rotor core so that the at least a flow path hole in the plurality of metal sheets defines the cooling channel, which is inclined at a predetermined slope with respect to the rotation axis of the rotor core,
wherein the cooling channel includes a first cooling channel, which is inclined from a first end surface to a second end surface of the rotor core with a first predetermined angle with respect to the rotation axis of the rotor core, and a second cooling channel, which is inclined from the second end surface to the first end surface of the rotor core with a second predetermined angle with respect to the rotation axis of the rotor core,
wherein cooling fluid is introduced into an inlet of the first cooling channel and an inlet of the second cooling channel, from a fluid flow channel formed inside a body of a rotor shaft to which the rotor core is coupled, and
wherein the fluid flow channel includes a first fluid flow channel passing through the body of the rotor shaft in an axial direction of the rotor shaft, and a second fluid flow channel connected to the first fluid flow channel and passing through the body of the rotor shaft in a radial direction of the rotor shaft in front of the first end surface of the rotor core, and a third fluid flow channel connected to the first fluid flow channel and passing through the body of the rotor shaft in the radial direction of the rotor shaft in front of the second end surface of the rotor core.
